(19) United States
(12) Patent Application Publication
(10) Pub. No.: US 2006/0101311 A1
(43) Pub. Date: May 11, 2006

(54) Connectivity between a scan tool and a remote device and method

(75) Inventors: Edward Lipscomb, Lakeville, MN (US); Troy Liebl, Owatonna, MN (US); Hemang Shah, Owatonna, MN (US); Lakshmy Kalivaradan, Owatonna, MN (US); Manokar Chinnadurai, Owatonna, MN (US)

Correspondence Address: BAKER & HOSTETLER LLP;Washington Square, Suite 1100, 1050 Connecticut Avenue, N.W., WASHINGTON, DC, 20036, US

(73) Assignee: SPX Corporation

(21) Appl. No.: 10/971,127

(22) Filed: Oct. 25, 2004

(51) Int. Cl. G06F 11/00

(52) U.S. Cl. 714/47

(57) ABSTRACT

A hand-held diagnostic tool is designed to operate and easily upgrade software applications developed for automotive diagnostics. The diagnostic tool, which communicates with a plurality of motor vehicle control units, provides application upgrades and/or modifications and/or new algorithms that are developed/adapted via remote updating. The tool comprises full diagnostic capability capable of receiving diagnostic data from a motor vehicle for storage, analysis and/or further data transfer to a remote device. The tool may further comprise wireless capability to perform data transfer operations. Remote updating is accomplished through a number of external ports on the tool that facilitate modem, Ethernet and wireless communications, including point-to-point protocol connection to the Internet.

### FIELD OF INVENTION

The present invention generally relates to the field of automotive diagnostics. More particularly, the present invention relates to a portable device designed to interface with onboard motor vehicle control computers, receive and/or collect vehicle diagnostic information and transmit the vehicle diagnostic information to a remote device.

### BACKGROUND OF THE INVENTION

Onboard control computers have become ubiquitous in motor vehicles, as safety, economy, and emissions requirements have continued to escalate, and conventional designs for reciprocating engines, friction braking systems, collision safety apparatus, and traction control devices have proven unequal to the requirements set out in law and the implicit demands of competitors' achievements. Successive generations of onboard control computers have acquired increasing data sensing and retention capability as the electronic art has advanced.

Present external diagnostic and display apparatus, known to those skilled in the art as scan tools, are commonly limited to reporting the data acquired by the onboard control computer itself. Increasingly subtle subsystem failures in automobiles overload the ability of maintenance technicians not simply to read the faults detected and stored by the scan tools themselves, but to combine those readings with peripheral measurements and deduce corrective actions with both speed and accuracy.

Accordingly, it is desirable to provide in the scan tool the ability to acquire and evaluate test data from sources other than the motor vehicle's onboard computer, and to combine those results with data acquired directly from the onboard computer.

Historically, diagnostic evaluation of a vehicle control system was performed by using designated, generally stand-alone type testing equipment that was coupled to the specific vehicle's control system. Vehicle control systems have become more computerized, electronic control units have been installed in motor vehicles. These control units include one or more micro-controllers used to control operation of a variety of vehicular control systems, such as engine, transmission, brakes or the steering mechanism.

Today in the automotive industry, there are hand-held diagnostic testers or tools used in connection with motor vehicle maintenance and repair. For instance, hand-held diagnostic tools have been used to trouble-shoot faults associated with vehicular control units. Typically such tools have included a micro-processor and an interface circuit to facilitate communication between the vehicle's electronic control unit and the tool's micro-processor. Each diagnostic tool has also included non-volatile internal or external memory, such as a plug-in module, that stores various diagnostic routines to enable the tool to communicate with a vehicle's control unit as well as provide information to a user.

However, in conventional practice, these diagnostic routines have been problematic in the area of upgrades. Typically, when a single diagnostic routine was added or modified, the new diagnostic routine to be added or modified had to be compiled and linked with the other existing routines before the combined routine, in its entirety, could be downloaded into a tool's non-volatile memory. These program upgrades and additions have therefore been difficult to accomplish and have resulted in downtime for the equipment that are inconvenient for the user. It is therefore desirable to provide a diagnostic tool that facilitates in part easy program upgrades.

Another concern within the scan tool industry includes an area of connectivity, i.e., the manner in which the scan tool is linked to additional user interfaces of remote devices, for example such as a personal computer (PC), in order to receive and/or transmit data thereto, for instance, as part of the vehicle analysis procedure. A direct wired approach, from the scan tool to another user interface of a remote device, such as a PC, may impose some difficulties to technicians performing diagnostic operations. For example, the wires can be cumbersome to maneuver around as technicians perform/analyze testing operations on the vehicle. Additionally, the operating range of the Scan Tool is necessarily limited to the length of any connected wire(s).

Accordingly, it is desirable to provide in the scan tool the ability to not only acquire and evaluate test data from sources other than the motor vehicle's onboard computer and to combine those results with data acquired directly from the onboard computer, but also to transfer data to another user interface of a remote device, such as, for example, via wireless connection technology.

### SUMMARY OF THE INVENTION

The foregoing need for a diagnostic tool wherein the diagnostic software can be easily upgraded is satisfied to a great extent by the present invention which is directed to a portable diagnostic tool that provides easy program upgrades/modifications via remote updating when, for example, diagnostic application programs are upgraded or new algorithms are developed or adapted. The diagnostic tool functions with an internal operating system that accesses software programs in the form of diagnostic routines residing in the internal memory, or on an external memory card. Each diagnostic routine is compiled and linked separately from the operating system and is separately downloadable into a non-volatile storage. device, such as the non-volatile memory, of the diagnostic tool.

More specifically, in one aspect of the present invention, program updates/modifications are accomplished via a compact flash card, which is configured to provide additional software programs and/or additional memory. In an exemplary embodiment, the compact flash card controls reads/writes to the internal and/or external flash memory, and interfaces with a compact flash card port on the diagnostic tool.

Alternatively and optionally, the compact flash card may be used with a smart card system for preventing the unauthorized downloading of software into a diagnostic tool. The smart card system preferably includes a smart card, which contains subscription information for the diagnostic tool, and a smart card reader device, which allows information stored within the smart card to be read and/or modified. The smart card serves as a controlled access security device. Preferably, the smart card reader device is part of the diagnostic tool.

Generally, for example, the smart card may only be used when a new software program is installed. An example of an installation operation may require the compact flash card to be inserted into the diagnostic tool along with smart card. As soon as the diagnostic tool verifies the smart card, the software is downloaded from the compact flash card into the tool's internal memory. After program installation, both cards (the flash card and the smart card) may be removed for storage in a secure place.

In another aspect of the present invention, program upgrades/modifications are accomplished via bulletin board systems (BBS), which interface with a tool's modem to provide software upgrades and/or modifications. In a preferred embodiment, in using the bulletin board system, a (point-to-point connection between the diagnostic tool and the BBS server is established using the tool's modem. Alternatively, connection may be established via a standard dial-up connection. Once a connection is established, the tool's software retrieves an index file containing a list of available diagnostic applications to download. This list is displayed to the user, who initiates a desired selection. Software internal to the diagnostic tool performs a verification process to determine if the tool has the ability to download the requested file.

In a preferred embodiment, one verification criteria is the existence of a valid smart card. Alternatively and optionally, another verification criteria is the existence of a valid application record stored on the internal hard drive of the tool. The internal record is a copy of the contents of a valid smart card. Upon successful verification, the tool automatically downloads a user's requested upgrade application, which is installed into the tool. If the verification process is unsuccessful, the tool notifies the user accordingly.

In another aspect of the present invention, program upgrades and/or modifications are accomplished via serial ports. In a preferred embodiment, upgrades and/or modifications can be provided to the diagnostic tool through a serial communication port to a personal computer. Preferably, the tool's serial port may comprise a Universal Serial Bus (USB) port, an IEEE 1394, an IrDA compatible infrared, an Ethernet or a RS-232 port, that is configured to communicate with a personal computer. For example, the USB or RS-232 port may be operatively connected to peripheral devices, such as keyboards, printers and memory hard drives.

Alternatively and optionally, upgrades and/or modifications can also be provided through a standard Personal Computer Memory Card International Association (PCMCIA) port. The PCMCIA port can accommodate a Personal Computer (PC) card to provide wireless technology, such as IEEE 802.11b capability or Bluetooth. Alternatively, an integrated built-in wireless technology may be utilized to provide wireless capability.

In another aspect of the present invention, program upgrades and/or modifications are accomplished by downloading the software from a server over the Internet via a communications protocol such as TCP/IP and PPP.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front plan view of a diagnostic tool according to a preferred embodiment of the present invention.

FIG. 2 is a screen shot of a real-time graph of the sensors in a side-by-side comparison arrangement.

FIG. 3 is a left side plan view of the diagnostic tool of FIG. 1 with a perspective view of compact flash card.

FIG. 4 is a plan view of the diagnostic tool of FIG. 1 with a perspective view of a smart card and a PC card.

FIG. 5 is a plan view of the diagnostic tool of FIG. 1 showing various serial ports.

FIG. 6 is a perspective view of the diagnostic tool of FIG. 1 with a Hardware Interface Module Port (HIP) in accordance with a preferred embodiment of the invention.

FIG. 7 shows a flow chart of an exemplary process for updating diagnostics routines employing, for example, the Internet/smart card/modem.

FIG. 8 depicts a diagnostic tool of FIG. 1 in connection with a vehicle electronic control unit.

FIG. 9 shows a general block diagram of a software package design in accordance with an embodiment of the present invention.

FIG. 10 depicts a diagnostic tool of FIG. 1 in connection with a vehicle electronic control unit and further wired connection with a remote device.

FIG. 11 depicts one embodiment of a diagnostic tool of FIG. 1 in connection with a vehicle electronic control unit and further wireless connection with a remote device.

### DETAILED DESCRIPTION OF PREFERRED EMBODIMENTS OF THE INVENTION

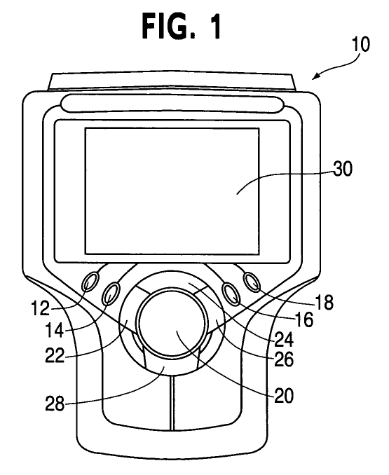

Referring now to the figures wherein like reference numerals indicate like elements, in FIG. 1 there is shown a diagram of a diagnostic tool 10 according to an embodiment of the present invention. The command key operations of the diagnostic tool, shown on the tool's front panel, consist of four areas: function keys 12, 14, 16, and 18, a cursor or direction key 20, and action keys 22, 24, 26, and 28. These keys are used for enter in instructions and/or data in the tool.

The function keys 12, 14, 16, and 18 activate unique commands. Each command function is displayed on the screen 30 of the diagnostic tool 10. The function 5 keys 12, 14, 16, and 18 are controlled by the software program and will preferably change as different parts of a diagnostic routine or procedure are displayed. The directional key 20 moves a command bar in a left, up, right or down direction on the screen 30.

The action keys 22, 24, 26, and 28 activate an action or request an application. In a preferred embodiment, the action keys 22, 24, 26, and 28 comprise a HELP key 22, which is depressed to request information for an option on the viewed screen; an ENTER key 24, which activates or selects a desired action; a MENU key 26 to go to the application manager menu; and an EXIT key 28 to move back (i.e. exit or quit) one screen at a time.

The diagnostic tool 10 display 30 is capable of displaying character, numeric and graphic information. The tool also includes a system setup utility, which provides basic operating system settings, such as system function configuration, contrast and print setup. The tool functions with an internal operating system that accesses software programs in the form of diagnostic routines.

For example, according to one embodiment of the present invention, a diagnostics routine or program processes vehicle control system data into an easily readable format, and then makes that data accessible through the diagnostic tool 10. The routine/program will read, graph and record sensor and switch input or output, including data stream. The routine/program also reads diagnostic trouble codes and performs special tests.

In a preferred embodiment, the diagnostics routine or program tests all On-Board Diagnostics Two (OBD II) applications, such as for example, those of General Motors, Saturn, Ford, Jeep and Chrysler. The diagnostics routine of the present invention is also capable of testing many imports equipped with the OBD II emissions standard system. It initiates the diagnostic process by creating a custom menu that lists tests and procedures available for each vehicle description entered into the routine/program. Preferably, the diagnostic tool can store up to 25 vehicle descriptions in files that can be re-used to re-enter a vehicle description.

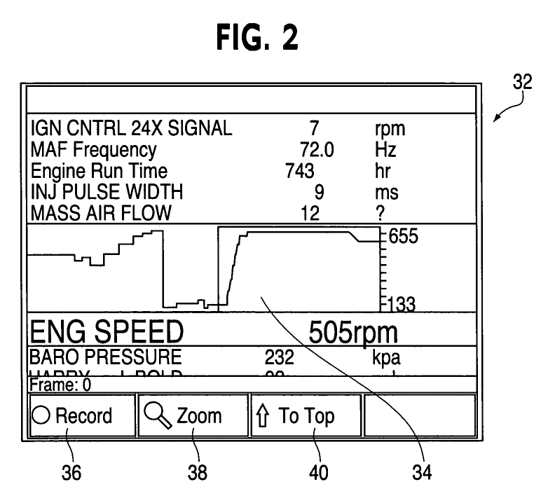

From the custom diagnostic menu a number of power test options can be selected. For example, a user or technician can select DATASTREAM to view sensor and switch data stream information communicated from the vehicle computer. Data stream is the electrical signal sent between the vehicle computer and the vehicle sensors or switches. The data is converted and displayed in a readable format for the repair technician. The DATASTREAM option of displaying data is shown in FIG. 2 wherein the data collected by sensors on an automobile can be arranged on-screen 32 side-by-side, viewed in a real-time graph 34, and also recorded and printed for examination or as a document.

In a preferred embodiment, as illustrated in FIG. 2, the data stream display format can arrange either a pre-selected group or all of the sensor and switch outputs detected from the vehicle. The arrangement may follow in alphabetical order.

In addition to the DATASTREAM option, the user or repair technician can press the function key 12 associated with the RECORD box 36 displayed on the screen 30 to quickly capture data that occurs before and after the function key is pressed; or view a file recorded when a diagnostic trouble code is detected. As shown in FIG. 2, other function keys would be associated with the ZOOM box 38 and the To Top box 40.

Also, the user can select DIAGNOSTIC CODES to view diagnostic trouble codes set by the vehicle computer. In a preferred embodiment, the diagnostic routine/program can view pending codes to see if a trouble code is about to be set. Preferably, it lists the General Motors OBD II trouble code designations of A, B, C and D to help lead the technician through problem diagnosis in order of importance.

Alternatively and preferably, the user can select SPECIAL TESTS to initiate many specific tests for vehicle sensors and, additionally, control General Motors bi-directional devices and view the immediate sensor reactions on-screen.

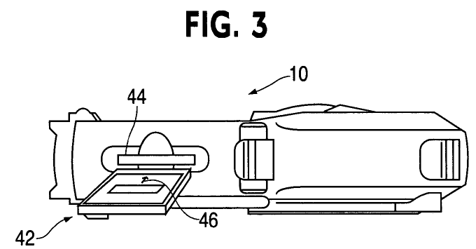

One aspect of the present invention that provides easy program upgrades and/or modification via remote updating, employs a compact flash card 42, as shown in FIG. 3. The compact flash card 42 is preferably used to provide additional software programs for the diagnostic tool 10. Alternatively and optionally, the compact flash card may be used to provide additional memory for the diagnostic tool. In an 20 exemplary embodiment, the compact flash card 42 controls reading and/or writing functions to the internal and/or external flash memory. It also interfaces with the compact flash card port or slot 44 located on the diagnostic tool 10.

In a preferred embodiment, the compact flash card 42 may be used in conjunction with a smart card system for preventing the unauthorized downloading of software in the diagnostic tool 10. A directional arrow 46 is aligned towards the flash card slot 44, and smoothly inserted until it clicks in place.

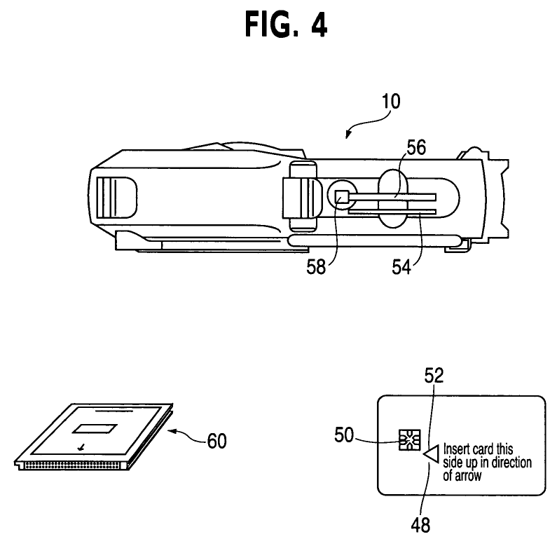

Referring to FIG. 4, the smart card 48 contains subscription information for the diagnostic routines and tool, according to the present invention. This information is stored on a smart card memory chip 50. Following the directional arrow 52, the smart card is inserted into a smart card slot 54 in the diagnostic tool 10.

Thus, once the flash card 42, FIG. 3, is inserted into the diagnostic tool 10 along with a smart card 48, the tool verifies the smart card 48 and, upon successful verification, the software is downloaded into the tool's memory.

In another aspect of the present invention, diagnostic program upgrades and/or modifications can be accomplished using bulletin board systems (BBS) via point-to-point protocol (PPP) connection, dial-up connection or normal log-in to a dedicated server. The diagnostic tool 10 is equipped with a PC card port 56 and eject button 58. A PC card 60 supplies capabilities including modem, Ethernet and wireless communications, such as an intranet and Internet.

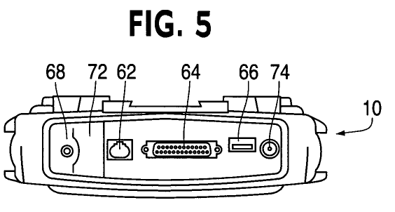

Remote updating is also accomplished via serial ports. In a preferred embodiment, program upgrades and/or modifications can be provided to the diagnostic tool through a variety of serial ports. For example, as shown in FIG. 5, the tool may be configured to include an RS-232 serial port 62, which is usable to communicate with a personal computer. The tool may also be configured to include a DB-25 pin port 64, which is used to connect a cable to a vehicle data link connector. While remote updating is not accomplished using port 64, it is important to note that communication with the computer installed in a vehicle requires an adapter cable connection 80 to the vehicle data link connector and to the diagnostic tool 10, and port 64 is a part of that communication link.

In addition, the diagnostic tool 10 may be configured to include a Universal Serial Bus (USB) port 66. This port 66 is capable of operative connection to peripheral devices, such as keyboards, printers and memory hard drives. Note the PC card slot/port 56, smart card slot/port 54 and compact flash card slot/port 44 as previously discussed. A power key 68 is also provided for turning power to the diagnostic tool 10 on and off.

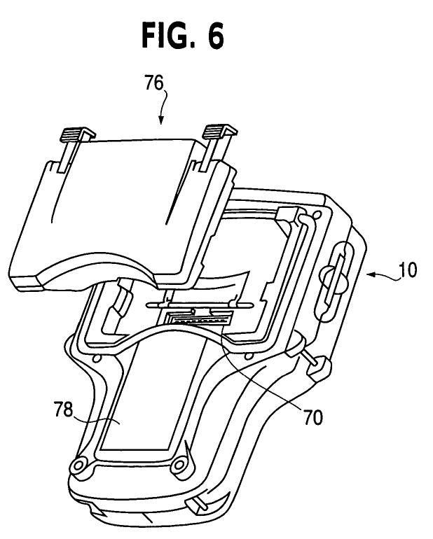

As shown in FIG. 6, in a preferred embodiment of the present invention, the diagnostic tool is also configured to include a Hardware Interface Module Port (HIP) pin connector 70. The HIP connector accepts a HIP module 76. The HIP module 76 enables implementation of cartridge-contained software programs. These software programs may be resident on cartridges and can include diagnostics routines directed to the Pathfinder 1999, for example.

Alternatively and optionally, the diagnostic tool may also be configured to include an infrared communication window 72, FIG. 5. The window 72 has infrared capability and can be used to communicate with a parallel printer (not shown) for wireless printing. An external power port 74 accepts 12 volt input for recharging an battery 78, FIG. 6.

Also, the tool is configurable to operate with a number of plug-in modules (i.e. HIP module 76), one of which is a cartridge reading device that allows the user to use existing software cartridges, such as diagnostic routines directed to the Pathfinder vehicle models, import models and Anti-locking Brake Systems (ABS), for example. Additional plug-in modules are configurable to provide features such as emission, lab scope, ignition, re-flash and multi-meter capabilities.

It is now apparent that the present invention has number of features and advantages over the prior art. For instance, the diagnostic tool is capable of communicating via the Internet using the TCP/IP protocol. Using the cartridge and card options, software upgrades can be disposed of after downloading. Using the compact flash card 42 for the dual purpose of upgrading additional memory, the diagnostic tool's memory and program routines can be updated by replacing the card rather than changing the board of each tool.

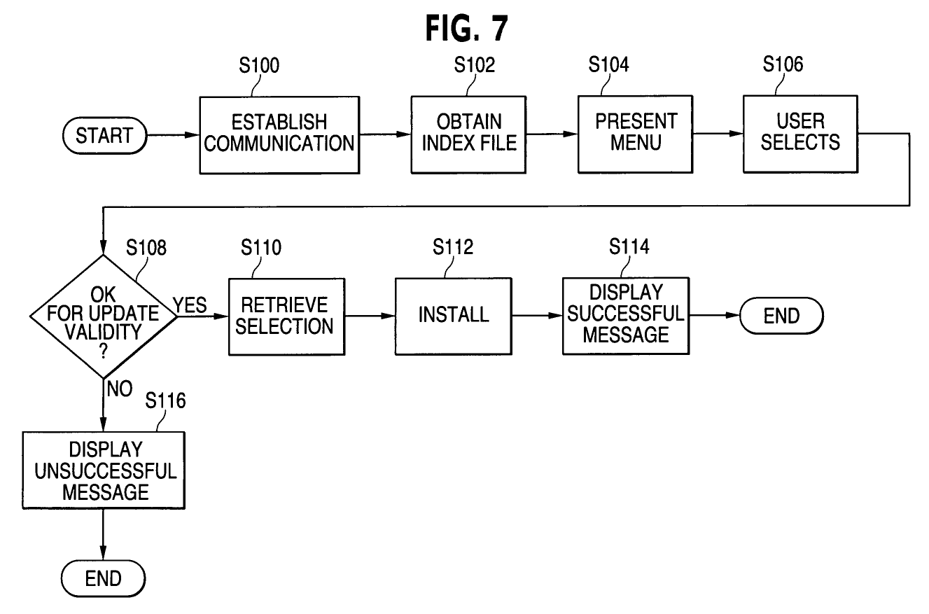

As shown in the flowcharts of FIG. 7, a method of updating diagnostics routines employing, for example, the Internet/smart card/modem, is provided.

In a preferred embodiment, in using a bulletin board system via the Internet, a user, such as a repair technician, operates the diagnostic tool 10 to trigger a dial-up connection to the bulletin board (Step 100 or S100). Communications may be established through a point-point protocol (PPP) connection between the diagnostic tool and the server, using the tool's modem. Alternatively, communications may be established through a standard dial-up connection. Furthermore, communications may be established using an Ethernet communication to a local network, or the like.

Once a connection is established, the tool's internal software obtains an index file, which contains a list of available downloadable diagnostic applications, and begins analyzing the existing diagnostic applications in the tool 10 (S102). A menu list of available applications is displayed to the user (S104), who initiates a desired upgrade or modification selection (S106).

At this juncture (S108), software internal to the diagnostic tool 10 performs a verification check for update validity; that is, the verification check process is to determine whether the tool has the ability to download the requested diagnostic application upgrade, for example. In a preferred embodiment, one verification criteria is the existence of a valid smart card. Alternatively and optionally, another verification criteria is the existence of a valid application record stored on the internal hard drive of the tool 10. Upon successful verification, the requested diagnostic application(s) is/are 10 retrieved (S110), and the application upgrade/modification is automatically downloaded or installed on the tool (S112). The tool then notifies the user that the upgrade or modification process is complete (S114). On the other hand, if verification is unsuccessful (S116), the user is notified with an appropriate display message on the tool 10.

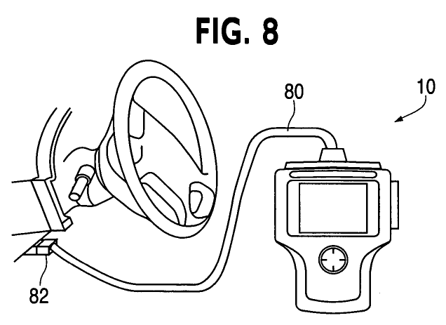

Thus, in operation, the diagnostic tool 10 may be configured to communicate with a vehicle data link connector, for instance, via the DB-25 pin port 64. As shown, for instance, in FIG. 8, an adapter cable connection 80 connects the vehicle data link connector 82 with the diagnostic tool 10 via port 64 as part of a communication link. A diagnostics routine or program may be utilized to process vehicle control system data into an easily readable format, and then make that data accessible through the diagnostic tool 10. Preferably, the routine/program will read, graph and record sensor and switch input or output, including data stream. The routine/program also reads diagnostic trouble codes and performs special tests. In a preferred embodiment, the diagnostics routine or program tests all On-Board Diagnostics Two (OBD II) applications, such as, for example, those of General Motors, Saturn, Ford, Jeep and Chrysler. The diagnostics routine of the present invention is also capable of testing most imports equipped with the OBD II emissions standard system.

Additionally, a remote device, such as a personal computer (PC), personal digital assistant (PDA), laptop, etc., may be configured to communicate with the diagnostic tool 10. In a preferred configuration, the remote device is connected to the diagnostic tool 10, which is in further connection to a vehicle's electronic control unit (ECU). A software package installed on the remote device and the diagnostic tool 10 will allow the diagnostic tool 10 to be operated through the remote device.

The installed software package can be utilized by the diagnostic tool 10 to read the vehicle information of the ECU, for instance, OBDII and OEM specific data of a selectable electronic module and pass it on to a remote device through a communication channel/link.

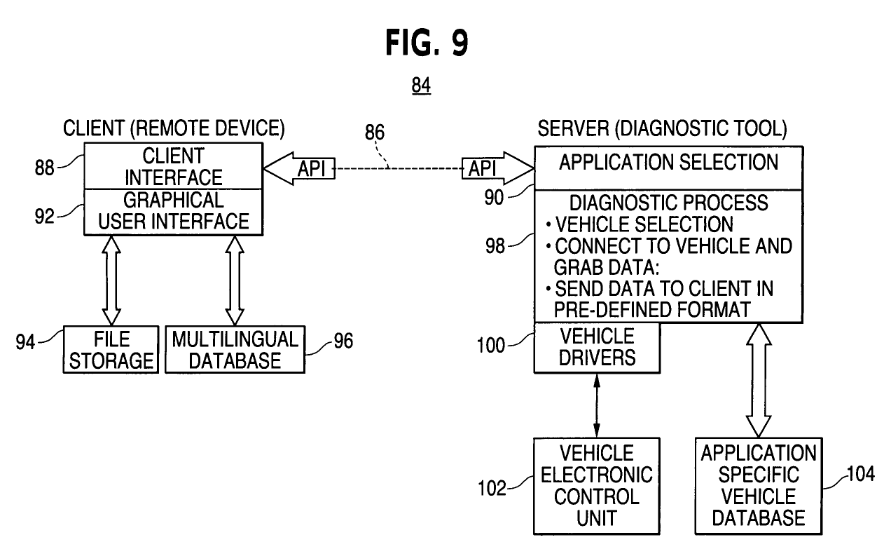

FIG. 9 depicts a general block diagram of a software package design 84 in accordance with an embodiment of the present invention. In a preferred setup, the diagnostic tool 10 acts as a server and the remote device acts as a client. An application programming interface (API) 86 links the client to the server via a client interface 88 and an application selection feature 90 respectively.

The client interface 88 initiates and handles communication to the server. A graphical user interface 92 may be coupled to the client interface 88 in order to provide additional functionality such as monitoring diagnostic data. Additionally, the client may provide further functionality such as providing file storage capability 94 and incorporating a multilingual database 96.

The application selection feature 90 of the server may also initialize communication such as to the client via the application programming interface 86. The application selection feature 90 may include a diagnostic process 98 to obtain vehicle diagnostic data. This process can entail selecting a particular vehicle, connecting to the vehicle and obtaining vehicle diagnostic data in order to send the data to the client. A necessary amount of vehicle drivers 100 can be implemented in order to enable the software package to communicate with the connected vehicle, for instance, via the vehicle electronic control unit 102. Additional application specific vehicle database information 104 may also be provided and/or shared by other applications, for instance, loaded on the diagnostic tool 10 and utilized in the diagnostic process 98.

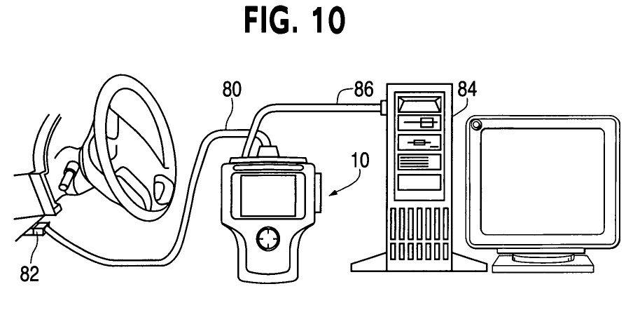

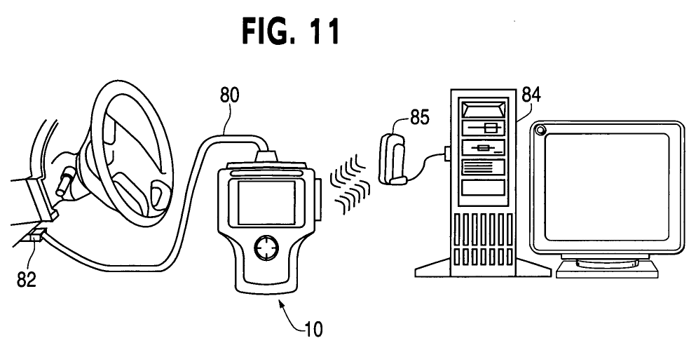

The application programming interface (API) 86 can be integrated in a variety of formats including, for examples, by wired or wireless connection as shown, for instance, in FIGS. 10 and 11 respectively. In one embodiment, FIG. 10 depicts a wired setup connection between the diagnostic tool 10 (connected to the vehicle data link connector 82) and a remote device such as PC 84. To connect the diagnostic tool 10 to the remote device, a serial cable 86 may be utilized such as one having a 9-pin connector at one end and an RJ45-pin connector on the other end.

Alternatively, FIG. 11 depicts a wireless setup connection between the diagnostic tool 10 (connected to the vehicle data link connector 82) and a remote device such as PC 84. To connect to the diagnostic tool 10 to the PC 84, the diagnostic tool 10 may implement a PCMCIA card via the PC Card 60 or incorporate wireless capable technology such as one using a wireless communication protocol e.g., IEEE 802.11b compatibility. Such wireless technology may be utilized within peripheral devices such as a USB adapter module 85 which link remote devices such as to PC 84 in order to enable wireless communication with the diagnostic tool 10. Additionally, the diagnostic tool 10 may communicate wirelessly with a remote device such as a PC, laptop, or PDA which utilize built-in wireless technology such as the IEEE 802.11b or Bluetooth standard.

Thus, the diagnostic tool 10 provides full functionality to receive and process vehicle diagnostic data from the vehicle itself. This may include displaying data grabbed from the vehicle on a display screen in different graphical and tabular formats when not connected to another remote device. Additionally, the aforementioned data can be recorded directly on to the diagnostic tool 10 for subsequent processing.

With the diagnostic tool 10 linked to the vehicle data link connector 82 and further connected to a remote device, a further advantage of the present configuration includes an ability to download diagnostic data from the diagnostic tool 10 to the remote device. Once received by the remote device, the information may be viewed, for instance, in selectable graphical formats, saved into appropriate storage devices attached to the remote device and/or further processed, such as file sharing via email or over the world wide web and/or printing reports. Hence, the data passed on to the remote device may be immediately processed/displayed in selectable graphical formats for analysis. The configuration of the present invention also provides for the aforementioned data to be simultaneously displayed on the diagnostic tool 10. A user may choose to record the aforementioned data on to an appropriate disk storage device installed on the remote device to perform further processing tasks such as printing reports or file sharing which may include, for instance, utilizing email or transferring data over the world wide web. An additional advantage of the present configuration may further provide an ability to view pre-recorded data by the remote device without having the diagnostic tool 10 or a vehicle connected.

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

What is claimed is:

1. A diagnostic tool for communicating with a vehicular electronic control unit and a remote device said diagnostic tool comprising:
a microprocessor for executing an operating system and one or more diagnostic application programs;
a non-volatile storage device, in the form of at least one of internal and external memory, coupled to said microprocessor; and
a user interface configured to receive and/or diagnose data from the vehicle control unit, wherein the user interface is also configured to transfer data gathered from the vehicle electronic control unit to the remote device.

2. The diagnostic tool of claim 1, wherein said user interface is configured for remote updating of at least one of a diagnostic application program and memory of said tool.

3. The diagnostic tool of claim 1, wherein said user interface of said tool is equipped with external ports usable for connecting communication and peripheral devices.

4. The diagnostic tool of claim 1, wherein said user interface includes a flash card port for supplying at least one of new application programs and upgrades to be loaded into said non-volatile storage device of said tool.

5. The diagnostic tool according to claim 2, wherein said tool memory and one or more resident diagnostic application programs are updated using a flash card.

6. The diagnostic tool of claim 1, wherein said user interface includes a PCMCIA card port for supplying modem, Ethernet and wireless communications.

7. The diagnostic tool of claim 1, wherein said user interface includes a smart card port for controlling authorized access of diagnostics application programs.

8. The diagnostic tool of claim 1, wherein said user interface includes one or more serial communication port usable to communicate with a remote device.

9. The diagnostic tool of claim 1, wherein said user interface includes an infrared communication area used for infrared communication with a desired peripheral device.

10. The diagnostic tool of claim 1, wherein said user interface includes a universal serial bus port for communicating with at least one of a keyboard, printer and memory hard drive.

11. The diagnostic tool of claim 1, wherein said user interface includes a hardware interface module port for enabling implementation of cartridge-contained software application programs.

12. The diagnostic tool of claim 11, wherein said user interface includes a hardware interface module port for enabling implementation of emission upgrades.

13. The diagnostic tool of claim 11, wherein said user interface includes a hardware interface module port for enabling implementation of lab scope upgrades.

14. The diagnostic tool of claim 11, wherein said user interface includes a hardware interface module port for enabling implementation of ignition upgrades.

15. The diagnostic tool of claim 11, wherein said user interface includes a hardware interface module port for enabling implementation of re-flash upgrades.

16. The diagnostic tool of claim 11, wherein said user interface includes a hardware interface module port for enabling implementation of multi-meter upgrades.

17. The diagnostic tool of claim 1, wherein said user interface includes an external power port for recharging an internal battery.

18. The diagnostic tool of claim 1, wherein said user interface includes a 25-pin port used to connect a cable to a vehicle data link connector.

19. The diagnostic tool according to claim 5, wherein said tool is capable of establishing a point to point link to the Internet.

20. The diagnostic tool according to claim 19, wherein at least one of diagnostic program upgrades and modifications to said tool is performed using a bulletin board system through a point-to-point protocol connection.

21. The diagnostic tool of claim 1, wherein said user interface includes integrated wireless technology.

22. The diagnostic tool of claim 20, wherein the integrated wireless technology is IEEE 802.11b compatible.

23. The diagnostic tool of claim 1, further comprising:
a display for viewing data in different formats.

24. A method of transferring data from an vehicular electronic control unit comprising:
providing a diagnostic tool;
connecting the diagnostic tool to the vehicular electronic control unit; and
transferring data from the vehicular electronic control unit via the diagnostic tool to a remote device.

25. The method of claim 24, wherein the diagnostic tool comprises:
executing an operating system and one or more diagnostic application programs via a microprocessor;
coupling a non-volatile storage device, in the form of at least one of internal and external memory, to said microprocessor; and
configuring a user interface to receive and/or diagnose data from the vehicle control unit, wherein the user interface is also configured to transfer data gathered from the vehicle electronic control unit to the remote device.

26. The method of claim 25 further comprising:
configuring the user interface for remote updating of at least one of a diagnostic application program and memory of said tool.

27. The method of claim 25, further comprising:
a display for viewing data in different formats.

28. The method of claim 25 wherein the data transfer is performed wirelessly.

29. The method of claim 28, wherein said user interface includes a PCMCIA card port for supply modem, Ethernet and wireless communications.

30. The method of claim 28, wherein said user interface includes integrated wireless technology.

31. The method of claim 30, wherein the integrated wireless technology is IEEE 802.11b compatible.

32. A system for transferring data from an vehicular electronic control unit comprising:
first means for receiving and processing data from the vehicular electronic control unit;
means for connecting the first data receiving and processing means to the vehicular electronic control unit; and
means for transferring data from the vehicular electronic control unit via the first data receiving and processing means to a second means for receiving and processing data.

33. The system of claim 32, wherein the first means for receiving and processing data comprises a diagnostic tool.

34. The system of claim 33, wherein the diagnostic tool further comprises:
a microprocessor for executing an operating system and one or more diagnostic application programs;
a non-volatile storage device, in the form of at least one of internal and external memory, coupled to said microprocessor; and
a user interface configured to receive and/or diagnose data from the vehicle control unit, wherein the user interface is also configured to transfer data gathered from the vehicle electronic control unit to the second data receiving and processing means.

35. The system of claim 32, wherein said user interface is configured for remote updating of at least one of a diagnostic application program and memory of said system.

36. The system of claim 34, further comprising:
a display for viewing data in different formats.

37. The system of claim 34 wherein the data transfer is performed wirelessly.

38. The system of claim 34, wherein said user interface includes a PCMCIA card port for supply modem, Ethernet and wireless communications.

39. The system of claim 34, wherein said user interface includes integrated wireless technology.

40. The system tool of claim 39, wherein the integrated wireless technology is IEEE 802.11b compatible.

41. The system of claim 32, wherein the second means for receiving and processing data comprises a remote device.

42. The system of claim 41, wherein the remote device includes one of a personal computer, a laptop, and a personal digital assistant.
